(19) United States
(12) Patent Application Publication
(10) Pub. No.: US 2023/0135462 A1
(43) Pub. Date: May 4, 2023

(54) CYANOACRYLATE COMPOSITIONS

(71) Applicant: Henkel AG & Co. KGaA, Duesseldorf (DE)

(72) Inventors: Tammy Gernon, Dublin (IE); Michael Jordan, Dublin (IE); Susan Reilly, Kildare (IE); Martin Smyth, Dublin (IE); Deborah Moore, Dublin (IE); Patricia Hedderman, Dublin (IE); Aine Mooney, Dublin (IE)

(21) Appl. No.: 18/086,788

(22) Filed: Dec. 22, 2022

Related U.S. Application Data
(63) Continuation of application No. PCT/EP2021/067440, filed on Jun. 24, 2021.

(30) Foreign Application Priority Data
Jun. 26, 2020 (GB) 2009826.5

(51) Int. Cl. C09J 4/00; C09J 5/06; C08F 22/32

(52) U.S. Cl. CPC C09J 4/00; C09J 5/06; C08F 22/32; C09J 2433/00; C09J 2400/163

(57) ABSTRACT

Cyanoacrylate compositions are provided, which when cured provide improved hot strength performance without compromising thermal resistance performance.

### BACKGROUND

### Field

This invention relates to cyanoacrylate-containing compositions, which when cured provide improved hot strength performance without compromising thermal resistance performance.

### Brief Description of Related Technology

Cyanoacrylate adhesive compositions are well known, and widely used as quick setting, instant adhesives with a wide variety of uses. See H. V. Coover, D. W. Dreifus and J. T. O'Connor, “Cyanoacrylate Adhesives” in Handbook of Adhesives, 27, 463-77, I. Skeist, ed., Van Nostrand Reinhold, New York, 3rd ed. (1990). See also G.H. Millet, “Cyanoacrylate Adhesives” in Structural Adhesives: Chemistry and Technology, S. R. Hartshorn, ed., Plenum Press, New York, p. 249-307 (1986).

In the past, efforts have been made to improve the thermal durability of cured products of cyanoacrylate composition, particularly upon exposure to elevated temperature conditions, such as 120° C., 150° C. and 180° C. As the cured products are thermoplastic in nature they tend to soften as the temperature increases and when the T_{g} of the material is surpassed the cured product begins to flow. As the temperature increase progresses, a degradation begins and the physical properties deteriorate. As a result, commercial applications for cyanoacrylates where exposure to elevated temperature conditions is likely have proven tricky and consequently have been limited.

Many attempts to remedy this situation have been undertaken in the past.

Additives such as thermal resistance conferring agents are known for use in cyanoacrylates, most of which involve additive chemistry though some involve the use of allyl cyanoacrylate and/or bis-cyanoacrylates. See e.g. U.S. Pat. No. 5,328,944 (Attarwala)(improved cyanoacrylate monomer adhesive formulations where the formulation includes an effective amount for enhancing the thermal resistance of the cured polymer of sulfur containing compounds of a specified the formula, including anhydrosulfites, sulfoxides, sulfites, sulfonates, methanesulfonates, p-toluenesulfonates, sulfinates, and cyclic sulfinates); U.S. Pat. No. 5,288,794 (Attarwala)(improved cyanoacrylate monomer adhesive formulations where the formulation includes an effective amount for enhancing the thermal resistance of the cured polymer of a mono, poly or hetero aromatic compound characterized by at least three substitutions on an aromatic ring thereof, two or more of the substitutions being electron withdrawing groups, examples of which aromatic compounds being 2,4-dinitrofluorobenzene, 2,4-dinitrochlorobenzene, 2,4-difluoronitrobenzene, 3,5-dinitrobenzonitrile, 2-chloro-3,5-dinitrobenzonitrile, 4,4′-difluoro-3,3′-dinitrophenyl sulfone, pentafluoronitrobenzone; pentafluorobenzonitrile, α,α,α-2-tetrafluoro-p-tolunitrile and tetrachloroterphthalonitrile); and U.S. Pat. No. 5,424,343 (Attarwala) (cyanoacrylate monomer adhesive formulations, curable to a polymer, comprising a cyanoacrylate monomer and an effective amount, for enhancing the thermal resistance of the cured polymer, of a naphthosultone compound substituted with at least one strong electron withdrawing group at least as strongly electron withdrawing as nitro) are a few examples.

In addition, the use of carboxylic acids and their anhydrides in cyanoacrylate compositions to improve thermal and moisture resistance is known. See e.g. U.S. Pat. No. 3,832,334 (addition of maleic anhydride, which is reported to produce cyanoacrylate adhesives having increased thermal resistance (when cured) while preserving fast cure speed); U.S. Pat. No. 4,196,271 (tri-, tetra- and higher carboxylic acids or their anhydrides, which are reported to be useful for improving heat resistance of cured cyanoacrylate adhesives); U.S. Pat. No. 4,450,265 (phthalic anhydride to improve heat resistance of cyanoacrylate adhesives); and U.S. Pat. No. 4,532,293 (benzophenonetetracarboxylic acid or its anhydride to provide a superior heat resistance).

Also the use of rubbers or elastomers as additives to toughen cyanoacrylates is known. See e.g. U.S. Pat. No. 4,440,910 (O'Connor)(use of certain organic copolymers of a lower alkene monomer and (i) acrylic acid esters, (ii) methacrylic acid esters or (iii) vinyl acetate as toughening additives that are elastomeric, i.e., rubbery, in nature); U.S. Pat. No. 9,944,830 (Attarwala)(rubber toughened cyanoacrylate, where the rubber toughening agent consists essentially of (a) reaction products of the combination of ethylene, methyl acrylate and monomers having carboxylic acid cure sites, (b) dipolymers of ethylene and methyl acrylate, and combinations of (a) and (b), and being substantially free of release agents, anti-oxidants, stearic acid and/or polyethylene glycol ether wax, with the further addition of N,N′-meta-phenylene bismaleimide; and phthalic anhydride); and U.S. Pat. No. 5,536,799 (Takahashi)(dipentaerythritol esters in cyanoacrylates to improve heat aging).

Recently, the Henkel Adhesive Technologies business invented several technologies to address improving thermal durability of cured cyanoacrylate compositions. One is directed to cyanoacrylate adhesive compositions, comprising: (a) a mono-functional cyanoacrylate component (such as allyl cyanoacrylate), and (b) a multi-functional cyanoacrylate component (such as a bis-cyanoacrylate). See U.S. Patent Application Publication No. 2017/0233618. Another is directed to cyanoacrylate-containing compositions that include, in addition to the cyanoacrylate component, a hydrogenated phthalic anhydride and optionally a benzonitrile. See U.S. Pat. No. 9,120,957 (Hedderman). Still another is U.S. Patent Application Publication No. 2018/0251659 (Tully), which provides a cyanoacrylate composition, which when cured provides improved thermal and humidity performance, through broadly speaking the combination of (a) a cyanoacrylate component, (b) a rubber toughening agent comprised of (i) reaction products of the combination of ethylene, methyl acrylate and monomers having carboxylic acid cure sites, (ii) dipolymers of ethylene and methyl acrylate, and combinations of (i) and (ii), (c) a component containing at least two (meth)acrylate functional groups, and (d) an anhydride component. Any yet another is U.S. Patent Application Publication No. 2020/0102480 (Tully), which provides (a) a cyanoacrylate component, (b) a toughening agent comprising a copolymer of polyethylene and polyvinyl acetate, (c) a component having at least two (meth)acrylate functional groups, (d) a benzonitrile component, and (e) an anhydride component.

Despite these efforts, there has been an ongoing desire to achieve more robust hot strength performance without compromising thermal resistance performance from cured cyanoacrylate compositions. It would accordingly be quite advantageous to provide such a solution to that long felt, yet unmet, need.

### SUMMARY

This invention provides such a solution.

By weaving through a thicket of known technology, the present inventors surprisingly found that by removing an additive that contributes to thermal resistance performance and including a collection of other additives, they were able to improve hot strength performance and still maintain a desirable level of thermal resistance performance as well.

Accordingly, the present invention provides a cyanoacrylate composition, which when cured provides improved hot strength performance without compromising thermal resistance performance. The composition includes (a) a cyanoacrylate component comprising a combination of (i) allyl cyanoacrylate and (ii) another cyanoacrylate selected from methyl cyanoacrylate, ethyl-2-cyanoacrylate, propyl cyanoacrylates, butyl cyanoacrylates, octyl cyanoacrylates, and β-methoxyethyl cyanoacrylate; (b) a fluorobenzonitrile; (c) a hydrogenated aromatic anhydride; and (d) a toughening component, such as an ethylene vinyl acetate copolymer and/or a polymer of ethylene, methyl acrylate and monomers having carboxylic acid cure sites.

Significantly, when the cyanoacrylate composition excludes hexane diol diacrylate, which contributes to thermal resistance performance in cyanoacrylate compositions (as noted in the '659 publication), not only is improved hot strength performance observed but thermal resistance performance is maintained too.

In addition, the toughening component should be present in an amount less than or equal to 8 percent by weight in order to improve hot strength performance without compromising thermal resistance performance. When present in an amount greater than 8 percent by weight, improvements in hot strength performance and/or maintenance of thermal resistance performance are not observed.

Unless otherwise stated percent by weight is the weight based on the total weight of the composition.

The observed performance improvements may be described as cured products of the cyanoacrylate composition demonstrating the following physical properties: (a) an initial bond strength of greater than or equal to about 18 N/mm²; (b) a bond strength after about 1,000 hours at a temperature of about 135° C. of greater than or equal to about 7 N/mm²; and c) a hot strength at about 135° C. of greater than or equal to about 3 N/mm².

This invention is also directed to a method of bonding together two substrate surfaces, which method includes applying to at least one of the substrate surfaces a composition as described above, and thereafter mating together the substrate surfaces.

In addition, the present invention is directed to cured products of the inventive compositions.

Also, the invention is directed to a method of preparing the inventive compositions.

The invention will be more fully understood by a reading of the section entitled “Detailed Description”, which follows.

### BRIEF DESCRIPTION OF THE FIGURES

FIG. 1 shows initial tensile strengths for cured products of cyanoacrylate formulations, labelled Sample Nos. 1 to 6, for grit blasted mild steel (GBMS) lap shear substrates.

FIG. 2 shows tensile strength performance of cured products of Sample Nos. 1 to 6 on GBMS lap shear substrates after heat ageing at 120° C., 135° C. and 150° C. over a time period of 1,000 hours.

FIG. 3 shows hot strength performance of cured products of Sample Nos. 1 to 6 on GBMS lap shear substrates at 120° C., 135° C. and 150° C.

### DETAILED DESCRIPTION

As noted above, this invention is directed to cyanoacrylate compositions, which when cured provide improved hot strength performance without compromising thermal resistance performance. The composition includes (a) a cyanoacrylate component comprising a combination of (i) allyl cyanoacrylate and (ii) another cyanoacrylate selected from the group consisting of methyl cyanoacrylate, ethyl-2-cyanoacrylate, propyl cyanoacrylates, butyl cyanoacrylates, octyl cyanoacrylates, and 5-methoxyethyl cyanoacrylate; (b) a fluorobenzonitrile; (c) a hydrogenated aromatic anhydride; and (d) a toughening component, such as an ethylene vinyl acetate copolymer and/or a polymer of ethylene, methyl acrylate and monomers having carboxylic acid cure sites.

Significantly, when the cyanoacrylate composition excludes hexane diol diacrylate, which is a contributor to thermal resistance performance as noted in the '659 publication, not only is improved hot strength performance observed but thermal resistance performance is maintained and not compromised.

In addition, the toughening component should be present in an amount less than or equal to 8 percent by weight in order to improve hot strength performance without compromising thermal resistance performance. When present in an amount greater than 8 percent by weight, improvements in hot strength performance and/or maintenance of thermal resistance performance are not observed, as will be discussed in more detail later.

The elevated temperature conditions at which hot strength performance and thermal resistance performance are evaluated include about 120° C. or greater, such as about 135° C. and about 150° C.

The hot strength is measured according to ISO 4587, where the lap shear strength is measured in an oven set to the temperature specified, after the adhesive specimens have cured for 24 hours at room temperature.

The thermal resistance, or durability, is measured according to ISO 4587, where the lap shear strength is measured at room temperature, after the adhesive specimens have cured for 24 hours at room temperature and have been aged for 1000 hours in an oven at the temperature specified prior to testing.

The cyanoacrylate component comprises a combination of (i) allyl cyanoacrylate and (ii) another cyanoacrylate selected from methyl cyanoacrylate, ethyl-2-cyanoacrylate, propyl cyanoacrylates, butyl cyanoacrylates, octyl cyanoacrylates, and 5-methoxyethyl cyanoacrylate. A particularly desirable combination is allyl cyanoacrylate and ethyl-2-cyanoacrylate.

The cyanoacrylate component should be included in the compositions in an amount within the range of from about 50 percent to about 99.98 percent by weight, with the range of about 80 percent to about 96 percent by weight, of the total composition being desirable.

The by weight ratio of the allyl cyanoacrylate and the other cyanoacrylate should be in the range of about 4:1 to about 1:4, such as about 2:1 to about 1:2, desirably about 1:1.

The fluorobenzonitrile may be chosen from any one or more of pentafluoronitrobenzene; pentafluorobenzonitrile; α, α, α-2-tetrafluoro-p-tolunitrile; and tetrafluoroisophthalonitrile.

The fluorobenzonitrile should be present in an amount of about 5 percent by weight, like about 0.01 percent to about 3 percent by weight, such as about 0.1 percent to about 1 percent by weight, with about 0.5 percent by weight being particularly desirable.

The hydrogenated aromatic anhydride should be a hydrogenated phthalic anhydride, such as 3,4,5,6-tetrahydro phthalic anhydride. However, isomeric versions thereof and partially hydrogenated versions of phthalic anhydride may also be used.

The hydrogenated phthalic anhydride should be used in an amount up to about 0.5 percent by weight, such as within the range of about 0.01 to about 0.2, desirably within the range of about 0.05 to about 0.1 percent by weight.

The toughening component may be chosen from one of several possibilities, but the amount of the toughening component used in the cyanoacrylate composition should be less than or equal to 8 percent by weight.

One such possibility is an ethylene vinyl acetate copolymer, which should comprise 30 percent by weight to 95 percent by weight vinyl acetate, such as about 50 percent by weight to about 90 percent by weight vinyl acetate, desirably about 90 percent by weight vinyl acetate based on the total weight of the copolymer.

Copolymers of polyethylene and polyvinyl acetate which are sold under the trade names LEVAMELT or LEVAPREN by Lanxess Limited are particularly desirable for use herein.

A range of LEVAMELT-branded copolymers is available and includes for example, LEVAMELT 400, LEVAMELT 600 and LEVAMELT 900. These copolymers differ in the amount of vinyl acetate present. For example, LEVAMELT 400 represents an ethylene-vinyl acetate copolymer comprising 40 percent by weight vinyl acetate based on the total weight of the copolymer.

The copolymer may be an ethylene-vinyl acetate copolymer comprising about 30 percent by weight vinyl acetate to about 95 percent by weight vinyl acetate, based on the total weight of the copolymer. For example, the copolymer may comprise about 50 percent by weight to about 95 percent by weight vinyl acetate, such as about 70 percent by weight to about 95 percent by weight vinyl acetate, desirably about 90 percent by weight, based on the total weight of the copolymer.

A particularly desirable copolymer comprises polyethylene and polyvinyl acetate where the vinyl acetate is present in an amount of 90 percent by weight based on the total weight of the copolymer.

A structural representation of the copolymer is depicted below:

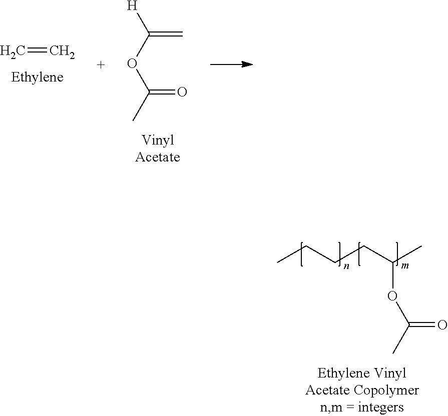

Another such possibility is a reaction product of the combination of ethylene, methyl acrylate and monomers having carboxylic acid cure sites. For example, an ethylene acrylic acid elastomer such as those available from Dupont under the trade name VAMAC, such as VAMAC N123 and VAMAC B-124, may be used. VAMAC N123 and VAMAC B-124 are reported by DuPont to be a master batch of ethylene/acrylic elastomer. The DuPont material VAMAC G is a similar copolymer but contains no fillers to provide colour or stabilizers. VAMAC VCS rubber appears to be the base rubber, from which the remaining members of the VAMAC product line are compounded. VAMAC VCS (previously known as VAMAC MR) is a reaction product of the combination of ethylene, methyl acrylate and monomers having carboxylic acid cure sites, which once formed is then substantially free of processing aids such as the release agents octadecyl amine, complex organic phosphate esters and/or stearic acid, and anti-oxidants, such as substituted diphenyl amine.

Alternatively, the toughening component may be a dipolymer of ethylene and methyl acrylate. In one variation of this alternative, the so-formed dipolymer is rendered substantially free of processing aids and anti-oxidants. Of course, the rubber toughening agent may be a combination of the reaction product of the preceding paragraph and the dipolymer of this paragraph, either of which or both may be rendered substantially free of processing aids and anti-oxidants.

The toughening component should be present in a concentration of about 1.5 percent by weight up to but not exceeding 8 percent by weight, such as about 5 percent by weight up to 8 percent by weight, with about 7 percent by weight up to 8 percent being particularly desirable. An amount over 8 percent by weight is undesirable.

As noted, the cyanoacrylate composition excludes hexane diol diacrylate (“HDDA”). While HDDA is known to improve thermal performance of cyanoacrylates, its presence has been shown to be deleterious to the hot strength of cured products of cyanoacrylate compositions. See infra Examples. Accordingly, HDDA is excluded from the inventive cyanoacrylate compositions.

Accelerators may be included in the inventive cyanoacrylate compositions, such as any one or more selected from calixarenes and oxacalixarenes, silacrowns, crown ethers, cyclodextrins, polyethyleneglycol) di(meth)acrylates, ethoxylated hydric compounds and combinations thereof.

Of the calixarenes and oxacalixarenes, many are known, and are reported in the patent literature. See e.g. U.S. Pat. Nos. 4,556,700, 4,622,414, 4,636,539, 4,695,615, 4,718,966, and 4,855,461, the disclosures of each of which are hereby expressly incorporated herein by reference.

For instance, as regards calixarenes, those within the following structure are useful herein:

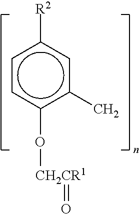

where R¹ is alkyl, alkoxy, substituted alkyl or substituted alkoxy; R² is H or alkyl; and n is 4, 6 or 8.

One particularly desirable calixarene is tetrabutyl tetra[2-ethoxy-2-oxoethoxy]calix-4-arene.

A host of crown ethers are known. For instance, examples which may be used herein either individually or in combination, or in combination with other first accelerator

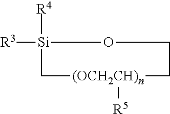

include 15-crown-5, 18-crown-6, dibenzo-18-crown-6, benzo-15-crown-5-dibenzo-24-crown-8, dibenzo-30-crown-10, tribenzo-18-crown-6, asym-dibenzo-22-crown-6, dibenzo-14-crown-4, dicyclohexyl-18-crown-6, dicyclohexyl-24-crown-8, cyclohexyl-12-crown-4, 1,2-decalyl-15-crown-5, 1,2-naphtho-15-crown-5, 3,4,5-naphtyl-16-crown-5, 1,2-methyl-benzo-18-crown-6, 1,2-methylbenzo-5, 6-methylbenzo-18-crown-6, 1,2-t-butyl-18-crown-6, 1,2-vinylbenzo-15-crown-5, 1,2-vinylbenzo-18-crown-6, 1,2-t-butyl-cyclohexyl-18-crown-6, asym-dibenzo-22-crown-6 and 1,2-benzo-1,4-benzo-5-oxygen-20-crown-7. See U.S. Pat. No. 4,837,260 (Sato), the disclosure of which is hereby expressly incorporated here by reference.

Of the silacrowns, again many are known, and are reported in the literature. For instance, a typical silacrown may be represented within the following structure: where R³ and R⁴ are organo groups which do not themselves cause polymerization of the cyanoacrylate monomer, R⁵ is H or CH₃ and n is an integer of between 1 and 4. Examples of suitable R³ and R⁴ groups are R groups, alkoxy groups, such as methoxy, and aryloxy groups, such as phenoxy. The R³ and R⁴ groups may contain halogen or other substituents, an example being trifluoropropyl. However, groups not suitable as R⁴ and R⁵ groups are basic groups, such as amino, substituted amino and alkylamino.

Specific examples of silacrown compounds useful in the inventive compositions include:

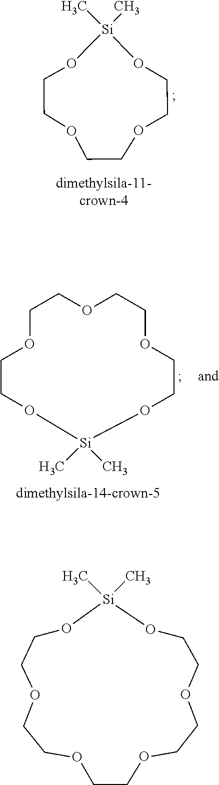 [SMILES: C[Si]1(C)OCCOCCOCCO1 ; C[Si]1(C)OCCOCCOCCOCCO1 ; C[Si]1(C)OCCOCCOCCOCCOCCO1]

dimethylsila-17-crown-6. See e.g. U.S. Pat. No. 4,906,317 (Liu), the disclosure of which is hereby expressly incorporated herein by reference.

Many cyclodextrins may be used in connection with the present invention. For instance, those described and claimed in U.S. Pat. No. 5,312,864 (Went), the disclosure of which is hereby expressly incorporated herein by reference, as hydroxyl group derivatives of an α, β or γ-cyclodextrin which is at least partly soluble in the cyanoacrylate would be appropriate choices.

For instance, poly(ethylene glycol) di(meth)acrylates suitable for use herein include those within the following structure:

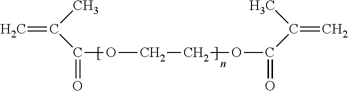

where n is greater than 3, such as within the range of 3 to 12, with n being 9 as particularly desirable. More specific examples include PEG 200 DMA (where n is about 4), PEG 400 DMA (where n is about 9), PEG 600 DMA (where n is about 14), and PEG 800 DMA (where n is about 19), where the number (e.g., 400) represents the average molecular weight of the glycol portion of the molecule, excluding the two methacrylate groups, expressed as grams/mole (i.e., 400 g/mol). A particularly desirable PEG DMA is PEG 400 DMA.

And of the ethoxylated hydric compounds (or ethoxylated fatty alcohols that may be employed), appropriate ones may be chosen from those within the following structure:

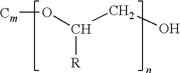

where Cₘ can be a linear or branched alkyl or alkenyl chain, m is an integer between 1 to 30, such as from 5 to 20, n is an integer between 2 to 30, such as from 5 to 15, and R may be H or alkyl, such as C₁₋₆ alkyl.

Commercially available examples of materials within the above structure include those offered under the DEHYDOL tradename from BASF SE, Lugwigshafen, Germany.

When used, the accelerator embraced by the above structures should be included in the compositions in an amount within the range of from about 0.01 percent by weight to about 10 percent by weight, with the range of about 0.1 percent by weight to about 0.5 percent by weight being desirable, and about 0.4 percent by weight of the total composition being particularly desirable.

A stabilizer package is also ordinarily found in cyanoacrylate compositions. The inventive cyanoacrylate compositions are no exception. The stabilizer package may include one or more free radical stabilizers and anionic stabilizers, each of the identity and amount of which are well known to those of ordinary skill in the art. See e.g. U.S. Pat. Nos. 3,742,018; 5,530,037 and 6,607,632, the disclosures of each of which are hereby incorporated herein by reference.

Commonly used free-radical stabilizers include phenolic ones, such as hydroquinone and derivatives thereof (see e.g. the '018 patent), while commonly used anionic stabilizers include boron triflouride, boron trifluoride-etherate, sulphur trioxide (and hydrolyis products thereof), sulfur dioxide and methane sulfonic acid.

Other additives may be included to confer additional physical properties, such as improved shock resistance (for instance, citric acid), thickness (for instance, polymethyl methacrylate), thixotropy (for instance, fumed silica), and color (for instance, dyes).

These other additives may be used in the inventive compositions individually in an amount from about 0.05 percent to about 20 percent, such as about 1 percent to 15 percent, desirably 5 percent to 10 percent by weight, depending of course on the identity of the additive. For instance, and more specifically, citric acid may be used in the inventive compositions in an amount of 5 to 500 ppm, desirably 10 to 100 ppm.

In another aspect, there is provided a method of bonding together two substrate surfaces, which method includes applying to at least one of the substrate surfaces a composition as described above, and thereafter mating together the substrates for a time sufficient to permit the adhesive to fixture. The substrate surfaces should become fixed by the compositions in less than about 150 seconds, and depending on the substrate as little as about 30 seconds. In addition, the composition should develop tensile strength on the substrate surfaces between which they have been applied, and as noted herein cured products thereof demonstrate improved hot strength performance while not compromising thermal duarbility.

In yet another aspect, there is provided cured products of the inventive compositions.

In still another aspect, there is provided a method of preparing the so-described compositions. The method includes providing the recited components of the cyanoacrylate composition, and mixing to form the cyanoacrylate composition.

In still yet another aspect, there is provided a method of bonding together two substrate surfaces. The method includes applying the cyanoacrylate composition to at least one of the substrate surfaces and mating together the substrate surfaces for a time sufficient to permit the cyanoacrylate composition to form a cured product thereof between the mated substrate surfaces.

In a further aspect, there is provided a method of preparing a cyanoacrylate-containing composition. The method includes providing components selected from (a) (i) allyl cyanoacrylate and (ii) another cyanoacrylate selected from methyl cyanoacrylate, ethyl-2-cyanoacrylate, propyl cyanoacrylates, butyl cyanoacrylates, octyl cyanoacrylates, and f-methoxyethyl cyanoacrylate; (b) a fluorobenzonitrile; (c) a hydrogenated aromatic anhydride; and (d) a toughening component; and mixing together the components for a time sufficient to form the cyanoacrylate composition.

In a still further aspect, there is provided a method of conferring improved hot strength to a cured product of a cyanoacrylate composition while maintaining thermal durability thereof. The method includes providing a cyanoacrylate composition comprising (a) a cyanoacrylate component comprising a combination of (i) allyl cyanoacrylate and (ii) another cyanoacrylate selected from the group consisting of methyl cyanoacrylate, ethyl-2-cyanoacrylate, propyl cyanoacrylates, butyl cyanoacrylates, octyl cyanoacrylates, and f-methoxyethyl cyanoacrylate; (b) a fluorobenzonitrile; (c) a hydrogenated aromatic anhydride; and (d) an ethylene vinyl acetate copolymer or a polymer of ethylene, methyl acrylate and monomers having carboxylic acid cure sites; applying the cyanoacrylate composition to at least one substrate surface and mating the cyanoacrylate composition-applied substrate surface(s) and maintaining the substrate surfaces in a mating relationship for a time sufficient to form a cured product of the cyanoacrylate composition therebetween to form a bonded assembly; and exposing the bonded assembly to elevated temperature conditions of about 120° C. or greater, such as about 135° C. or about 150° C.

In one embodiment the inventive cyanoacrylate composition includes the cyanoacrylate component present in an amount of about 90 percent by weight, with the allyl cyanoacrylate and the ethyl-2-cyanoacrylate being present in a percent by weight ratio of about 1.5:1 to about 1:1.5, desirably in about equal amounts; the hydrogenated aromatic anhydride being tetrahydrophthalic anhydride and present in an amount of less than about 0.1 percent by weight, desirably about 0.05 percent by weight to about 0.1 percent by weight; the fluorobenzonitrile being pentafluorobenzonitrile and present in an amount of less than about 1 percent by weight, desirably about 0.5 percent by weight to about 1 percent by weight; and the toughneing component present in an amount of about 5 percent up to 8 percent by weight of the total composition.

In another embodiment the inventive cyanoacrylate composition includes (a) a cyanoacrylate component comprising a combination of (i) allyl cyanoacrylate and (ii) another cyanoacrylate selected from methyl cyanoacrylate, ethyl-2-cyanoacrylate, propyl cyanoacrylates, butyl cyanoacrylates, octyl cyanoacrylates, and f-methoxyethyl cyanoacrylate; (b) a fluorobenzonitrile; (c) a hydrogenated aromatic anhydride; and (d) an ethylene vinyl acetate copolymer, such as one with about 90% vinyl acetate content or a polymer of ethylene, methyl acrylate and monomers having carboxylic acid cure sites; and (e) optionally, a stabilizing amount of an acidic stabilizer and a free radical inhibitor; and (f) optionally, an accelerator component; and (g) optionally, shock resistant additives; and (h) optionally, thixotropy conferring agents; and (i) optionally, thickeners; and (j) optionally, dyes.

The inventive cyanoacrylate compositions show improved hot strength performance and in so doing do not compromise the thermal resistance performance. Advantageously, the inventive cyanoacrylate compositions when cured at room temperature betweeen two substrates, each of which being constructed from steel, demonstrate the following physical properties: (a) an initial bond strength of greater than or equal to about 18 N/mm²; (b) a bond strength after about 1,000 hours at a temperature of about 135° C. of greater than or equal to about 7 N/mm²; and c) a hot strength at about 135° C. of greater than or equal to about 3 N/mm².

These aspects of the invention will be further illustrated by the examples which follow.

### EXAMPLES

In the examples, various compostions have been formulated and evaluated to highlight the benefits and advantages of the inventive compositions. In the compositions set forth in Table 1 below, a number of consitutents have been used and varied, in both identity and amount. Sample No. 3 included HDDA. Sample No. 2 included calixarene and a crown ether, whereas the reamining samples each included only a crown ether. Sample No. 1 also included PMMA; Sample No. 2 also included silica and a bismaleimide. In addition, Sample Nos. 5 and 6 included citric acid. All samples included a stabilizer package.

TABLE 1

| | | Sample Nos./Amt (wt %) | | | | | |
|---|---|---|---|---|---|---|---|
| Constituents | | 1 | 2 | 3 | 4 | 5 | 6 |
| CA | Ethyl CA | 92 | 83 | 44 | 44 | 46 | 46 |
| | Allyl CA | — | — | 40 | 44 | 45 | 45 |
| Nitrile | Pentafluoro | 0.5 | — | 0.5 | 0.5 | 0.8 | 0.8 |
| | benzonitrile | | | | | | |
| Anhydride | Tetra- | 0.09 | — | 0.09 | 0.09 | 0.09 | 0.09 |
| | hydrophthalic | | | | | | |
| | anhydride | | | | | | |
| | Phthalic | — | 0.5 | — | — | — | — |
| | anhydride | | | | | | |
| Copolymer | VAMAC VCS | — | 8 | 10 | 10 | 7.5 | — |
| | 5500 | | | | | | |
| | LEVAPREN | — | — | — | — | — | 8 |
| | 900 | | | | | | |

The results of the evaluation, captured in Tables 2-4 and FIGS. 1-3, illustrate the surprising and unexpected performance of the inventive compositions (Sample Nos. 5 and 6) against those (Sample Nos. 1-4) chosen for comparison.

TABLE 2

| | Lap Shear Strength on |
|---|---|
| Sample Nos. | GBMS (N/mm²) |
| 1 | 17.6 |
| 2 | 23.7 |
| 3 | 18.7 |
| 4 | 19.5 |
| 5 | 20.6 |
| 6 | 18.4 |

The initial lap shear strength on grit-blasted mild steel (GBMS) after 24 hour room temperature cure for Sample Nos. 1 to 6 is shown to range from 18.4 to 23.7 N/mm² (Table 2; FIG.

TABLE 3

| | Lap Shear Strength on GBMS (N/mm²) | | |
|---|---|---|---|
| | After 1000 hours | After 1000 hours | After 1000 hours |
| Sample Nos. | at 120° C. | at 135° C. | at 150° C. |
| 1 | 6.0 | 0 | 0 |
| 2 | 5.5 | 0 | 0 |
| 3 | 4.9 | 9.4 | 6.0 |
| 4 | 4.9 | 10.2 | 7.4 |
| 5 | 6.9 | 7.9 | 7.3 |
| 6 | 7.6 | 7.0 | 4.6 |

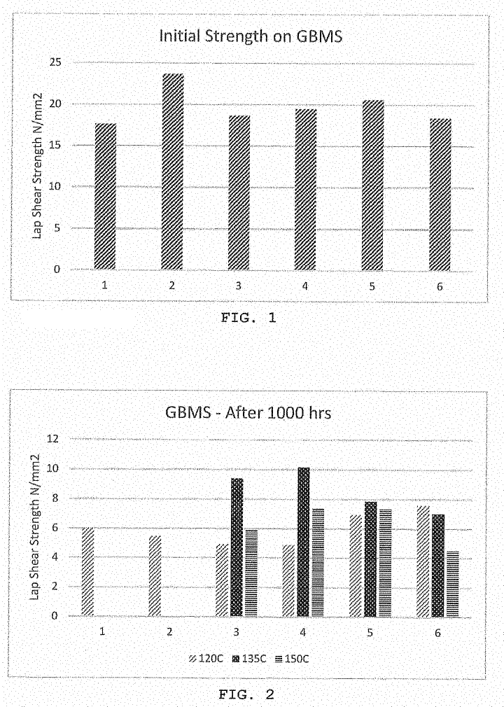

The thermal resistance performance of these samples was investigated by ageing the cured adhesive on GBMS for 1000 hours at the following increasing temperatures: 120° C., 135° C. and 150° C. (Table 3; FIG. 2). Here, Sample Nos. 1-2 were observed to maintain a lap shear strength of >5 N/mm² after 1000 hours at 120° C. However, these samples also show no strength after 1000 hours at 135° C. and 150° C. In comparison, Sample Nos. 3 to 6 demonstrate improved thermal resistance performance (durability) after 1000 hours, particularly at the higher temperatures of 135° C. and 150° C.

TABLE 4

| | Hot Strength on GBMS Lap Shears (N/mm²) | | |
|---|---|---|---|
| Sample Nos. | at 120° C. | at 135° C. | at 150° C. |
| 1 | 8.1 | 3.5 | 1.7 |
| 2 | 7.1 | 4.0 | 1.7 |
| 3 | 2.2 | 1.0 | 0.7 |
| 4 | 2.0 | 4.6 | 1.3 |
| 5 | 7.6 | 4.4 | 1.3 |
| 6 | 6.6 | 3.3 | 1.7 |

However, when evaluating high temperature performance as a whole, the hot strength performance of the cyaoacrylate composition is a useful measure. Hot strength of 3 N/mm² at a particular temperature, combined with a thermal resistance resistance performance (durability) of 7 N/mm², is considered sufficient to indicate thermal performance at that temperature.

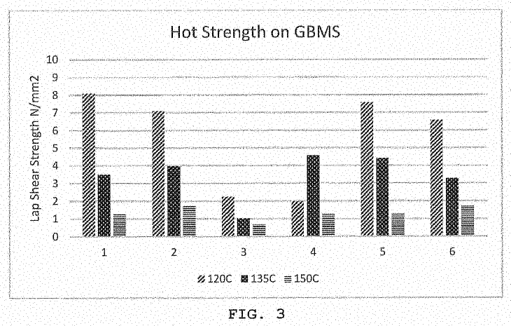

Thus, the hot strength observed for Sample Nos. 1 to 6 was determined by measuring the lap shear strength of the cured compositions on GEMS at 120° C., 135° C. and 150° C. (Table 4; FIG. 3).

Sample Nos. 1-2 have a sufficient hot strength at both 120° C. and 135° C. However, these samples show poor thermal resistance performance (durability) at 135° C., which means that these cyanoacrylate composition at best would only be considered to have high temperature performance at temperatures up to 120° C. Sample No. 3, containing HDDA, does not meet the threshold requirement of 3 N/mm² at any of the elevated temperatures at which evlautions were conducted—i.e., 120° C., 135° C. and 150° C. So, despite having thermal resistance performance (durability) at these temperatures, Sample No. 3 does not meet the requirement for overall high temperature performance.

Sample Nos. 4-6 demonstrate the improvement in hot strength performance that can be achieved by the exclusion of HDDA. But, significantly and unexepectedly, Sample Nos. 5 and 6 show a hot strength 3 N/mm² at both 120° C. and 135° C., without compromising thermal resistance performance.

What is claimed is:

1. A cyanoacrylate composition, comprising:
(a) a cyanoacrylate component comprising a combination of (i) allyl cyanoacrylate and (ii) another cyanoacrylate selected from the group consisting of methyl cyanoacrylate, ethyl-2-cyanoacrylate, propyl cyanoacrylates, butyl cyanoacrylates, octyl cyanoacrylates, and β-methoxyethyl cyanoacrylate;
(b) a fluorobenzonitrile;
(c) a hydrogenated aromatic anhydride; and
(d) a toughening component.

2. The cyanoacrylate composition of claim 1 provided the cyanoacrylate composition excludes hexane diol diacrylate.

3. The cyanoacrylate composition of claim 1, wherein cured products thereof demonstrate the following physical properties: (a) an initial bond strength of greater than or equal to about 18 N/mm²; (b) a bond strength after about 1,000 hours at a temperature of about 135° C. of greater than or equal to about 7 N/mm²; and c) a hot strength at about 135° C. of greater than or equal to about 3 N/mm².

4. The cyanoacrylate composition of claim 3, wherein the physical properties were measured on steel substrates.

5. The cyanoacrylate composition of claim 1, wherein the allyl cyanoacrylate and the another cyanoacrylate are present in ratio of about 1:1 percent by weight.

6. The cyanoacrylate composition of claim 1, wherein the fluorobenzonitrile is selected from pentafluoronitrobenzene;
pentafluorobenzonitrile; α, α, α-2-tetrafluoro-p-tolunitrile;
and tetrafluoroisophthalonitrile.

7. The cyanoacrylate composition of claim 1, wherein the fluorobenzonitrile is present in an amount of about 0.01 percent to about 3 percent by weight.

8. The cyanoacrylate composition of claim 1, wherein the hydrogenated aromatic anhydride is selected from tetrahydrophthalic anhydride is 3,4,5,6-tetrahydro phthalic anhydride.

9. The cyanoacrylate composition of claim 1, wherein the hydrogenated aromatic anhydride is present in an amount of up to about 0.5 percent by weight.

10. The cyanoacrylate composition of claim 1, wherein the fluorobenzonitrile is present in an amount about an order of magnitude greater than the hydrogenated aromatic anhydride.

11. The cyanoacrylate composition of claim 1, wherein the toughening component is present in an amount of about 5 up to 8 percent by weight.

12. The composition according to claim 1, further comprising a filler.

13. The composition according to claim 12, wherein the filler is selected from the group consisting of carbon black, silica and combinations thereof.

14. The composition of claim 1, further comprising a stabilizing amount of an acidic stabilizer and a free radical inhibitor.

15. The composition of claim 1, wherein the toughening component is selected from the group consisting of an ethylene vinyl acetate copolymer, a polymer of ethylene, methyl acrylate and monomers having carboxylic acid cure sites, and combinations thereof.

16. The composition according to claim 1, further comprising an accelerator component selected from the group consisting of calixarene, oxacalixarene, silacrown, cyclodextrin, crown ether, poly(ethyleneglycol) di(meth)acrylate, ethoxylated hydric compound, and combinations thereof.

17. The composition according to claim 16, wherein the calixarene is tetrabutyl tetra[2-ethoxy-2-oxoethoxy]calix-4-arene.

18. The composition according to claim 16, wherein the crown ether is selected from the group consisting of 15-crown-5, 18-crown-6, dibenzo-18-crown-6, benzo-15-crown-5-dibenzo-24-crown-8, dibenzo-30-crown-10, tribenzo-18-crown-6, asym-dibenzo-22-crown-6, dibenzo-14-crown-4, dicyclohexyl-18-crown-6, dicyclohexyl-24-crown-8, cyclohexyl-12-crown-4, 1,2-decalyl-15-crown-5, 1,2-naphtho-15-crown-5, 3,4,5-naphtyl-16-crown-5, 1,2-methyl-benzo-18-crown-6, 1,2-methylbenzo-5, 6-methylbenzo-18-crown-6, 1,2-t-butyl-18-crown-6, 1,2-vinylbenzo-15-crown-5, 1,2-vinylbenzo-18-crown-6, 1,2-t-butyl-cyclohexyl-18-crown-6, asym-dibenzo-22-crown-6, and 1,2-benzo-1,4-benzo-5-oxygen-20-crown-7 and combinations thereof.

19. The composition according to claim 16, wherein the poly(ethyleneglycol) di(meth)acrylate is within the following structure: 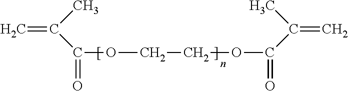
wherein n is greater than 3.

20. The composition according to claim 1, further comprising additives selected from the group consisting of shock resistant additives, thixotropy conferring agents, thickeners, dyes, thermal degradation resistance enhancers, and combinations thereof.

21. A cyanoacrylate composition, comprising:
(a) a cyanoacrylate component comprising a combination of (i) allyl cyanoacrylate and (ii) another cyanoacrylate selected from the group consisting of methyl cyanoacrylate, ethyl-2-cyanoacrylate, propyl cyanoacrylates, butyl cyanoacrylates, octyl cyanoacrylates, and 5-methoxyethyl cyanoacrylate, wherein (i) and (ii) are present in a percent by weight ratio of about 1.5:1 to about 1:1.5;
(b) a fluorobenzonitrile in an amount of less than about 1.0 percent by weight;
(c) a hydrogenated aromatic anhydride in an amount of less than about 0.1 percent by weight; and
(d) an ethylene vinyl acetate copolymer with about 90% vinyl acetate content, in an amount of less than about 8 percent by weight.

22. A cyanoacrylate composition, consisting of:
(a) a cyanoacrylate component comprising a combination of (i) allyl cyanoacrylate and (ii) another cyanoacrylate selected from the group consisting of methyl cyanoacrylate, ethyl-2-cyanoacrylate, propyl cyanoacrylates, butyl cyanoacrylates, octyl cyanoacrylates, and β-methoxyethyl cyanoacrylate;
(b) a fluorobenzonitrile;
(c) a hydrogenated aromatic anhydride; and
(d) an ethylene vinyl acetate copolymer with about 90% vinyl acetate content; and
(e) optionally, a stabilizing amount of an acidic stabilizer and a free radical inhibitor; and
(f) optionally, an accelerator component; and
(g) optionally, shock resistant additives; and
(h) optionally, thixotropy conferring agents; and
(i) optionally, thickeners; and
(j) optionally, dyes.

23. Cured products of the composition according to claim 1.

24. A method of bonding together two substrate surfaces, comprising the steps of:
applying a cyanoacrylate composition according to claim 1, to at least one of the substrate surfaces and
mating together the substrate surfaces for a time sufficient to permit the cyanoacrylate composition to form a cured product thereof between the mated substrate surfaces.

25. A method of preparing a cyanoacrylate-containing composition according to claim 1, comprising the step of:
providing components selected from:
(a) (i) allyl cyanoacrylate and (ii) another cyanoacrylate selected from the group consisting of methyl cyanoacrylate, ethyl-2-cyanoacrylate, propyl cyanoacrylates, butyl cyanoacrylates, octyl cyanoacrylates, and β-methoxyethyl cyanoacrylate;
(b) a fluorobenzonitrile;
(c) a hydrogenated aromatic anhydride; and
(d) a toughening component; and
mixing together said component for a time sufficient to form said cyanoacrylate composition.

26. A method of conferring improved hot strength to a cured product of a cyanoacrylate composition while maintaining thermal durability thereof, comprising the steps of:
providing a cyanoacrylate composition comprising (a) a cyanoacrylate component comprising a combination of (i) allyl cyanoacrylate and (ii) another cyanoacrylate selected from the group consisting of methyl cyanoacrylate, ethyl-2-cyanoacrylate, propyl cyanoacrylates, butyl cyanoacrylates, octyl cyanoacrylates, and β-methoxyethyl cyanoacrylate; (b) a fluorobenzonitrile; (c) a hydrogenated aromatic anhydride; and (d) an ethylene vinyl acetate copolymer or a polymer of ethylene, methyl acrylate and monomers having carboxylic acid cure sites;
applying the cyanoacrylate composition to at least one substrate surface and mating the cyanoacrylate composition-applied substrate surface(s) and maintaining the substrate surfaces in a mating relationship for a time sufficient to form a cured product of the cyanoacrylate composition therebetween to form a bonded assembly; and
exposing the bonded assembly to elevated temperature conditions of about 120° C. or greater.

27. The method according to claim 26, wherein the elevated temperature conditions are about 135° C.

28. The method according to claim 26, wherein the elevated temperature conditions are about 150° C.

29. The method according to claim 26, wherein the substrate(s) is(are) constructed of steel.

30. The method according to claim 26, wherein the thermal durability is substantially maintained showing a bond strength after about 1,000 hours at a temperature of about 135° C. of greater than or equal to about 7 N/mm² and the hot strength at the elevated temperature conditions is greater than or equal to 3 N/mm², when the cyanoacrylate composition is disposed and cured between substrates constructed of steel.
